(19) United States
(12) Patent Application Publication
(10) Pub. No.: US 2014/0229764 A1
(43) Pub. Date: Aug. 14, 2014

(54) MANAGEMENT OF A COMPUTER

(71) Applicants: Theodore F. Emerson, Tomball, TX (US); Don A. Dykas, Houston, TX (US); Robert L. Noonan, Crystal Lake, IL (US); David F. Heinrich, Tomball, TX (US)

(72) Inventors: Theodore F. Emerson, Tomball, TX (US); Don A. Dykas, Houston, TX (US); Robert L. Noonan, Crystal Lake, IL (US); David F. Heinrich, Tomball, TX (US)

(21) Appl. No.: 14/348,202

(22) PCT Filed: Oct. 28, 2011
(86) PCT No.: PCT/US2011/058302

§ 371 Date: Mar. 28, 2014

(51) Int. Cl. G06F 11/20

(52) U.S. Cl. CPC G06F 11/2028
USPC 714/13

(57) ABSTRACT

An embodiment of the present techniques provides for a system and method for a managed computer system. A system may comprise a host processor. The system may also comprise a management subsystem that includes a primary processor. The primary processor performs system management operations of the computer. The system may also comprise an autonomous management processor that is assigned to perform low level functions during a time interval when the primary processor is unavailable.

### BACKGROUND

Hardware management subsystems typically use a single primary processing unit alongside a multi-tasking, embedded operating system (OS) to handle the management functions of a larger host computer system. Typically, hardware management subsystems perform critical functions in order to maintain a stable operating environment for the host computer system. Accordingly, if the hardware management subsystem is unavailable for any reason, the host computer may lose some critical functions or be subject to impaired performance, such as being susceptible to hangs or crashes.

### BRIEF DESCRIPTION OF THE DRAWINGS

Certain exemplary embodiments are described in the following detailed description and in reference to the drawings, in which:

FIG. 1A is a block diagram of a managed computer system according to an embodiment of the present techniques;

FIG. 1B is a continuation of the block diagram of a managed computer system according to an embodiment of the present techniques;

FIG. 2A is a process flow diagram showing a method of providing a managed computer system according to an embodiment of the present techniques;

FIG. 2B is a process flow diagram showing a method of performing low level functions according to an embodiment of the present techniques; and

FIG. 3 is a block diagram showing a non-transitory, computer-readable medium that stores code for providing a managed computer system according to an embodiment of the present techniques.

### DETAILED DESCRIPTION OF SPECIFIC EMBODIMENTS

Embedded systems may be designed to perform a specific function, such as hardware management. The hardware management subsystem may function as a subsystem of a larger host computer system, and is not necessarily a standalone system. Moreover, many embedded systems include their own executable code, which may be referred to as an embedded OS or firmware. An embedded system may or may not have a user interface. Additionally, an embedded system may include its own hardware.

Typically baseboard management controllers (BMCs) and other management subsystems are designed using a single large management CPU. The BMCs and other management subsystems may also contain smaller autonomous processing units. The processing elements of a management architecture that are designed to provide global subsystem control or direct user interaction may be referred to herein as primary processing units (PPUs). The processing elements of the management architecture that are designed to assist the PPUs may be referred to as autonomous processing units (APUs). The PPUs may provision the APUs, and the APUs may include independent memory, storage resources, and communication links. The APUs may also share resources with the PPUs. In many cases, however, the APUs will have reduced dedicated resources relative to a PPU. For example, APUs may have lower speed connections, less directly coupled memory, or reduced processing power relative to a PPU. APUs may be used in a wide range of situations to relieve or back up the operations of the PPU. For example, an APU may be provisioned by the PPU to control some management features that may be built into the system board, such as diagnostics, configuration, and hardware management. The APU can control these management features without input from the subsystem PPU. Similarly, an APU may be tasked with communicating directly with input/output (I/O) devices, thereby relieving the PPU from processing functions that involve I/O transfers. Through the use of PPUs and APUs, the processor of the host computer (host processor) may rely on the management type processors to provide boot and operational services. Accordingly, the reliability and stability of the hardware management architecture may assist in achieving a reliable and stable computing platform for a host processor.

In embodiments, the present techniques can include a host processor and a management subsystem with both a primary processor, such as a PPU, and an autonomous management processor, such as an APU. In embodiments, the primary processor can perform system management operations of the computer while the autonomous processor performs low level functions during a time interval when the primary processor is unavailable. Further, in embodiments, the autonomous processor can be assigned low level functions while the primary processor remains available and performs other functions. Embodiments of the present techniques can be useful in ensuring a stable environment for the host server. Accordingly, in embodiments, a crashed hardware management subsystem may be prevented from disrupting the host server platform. Further, hardware management subsystem firmware upgrades may be performed without jeopardizing the host server operation.

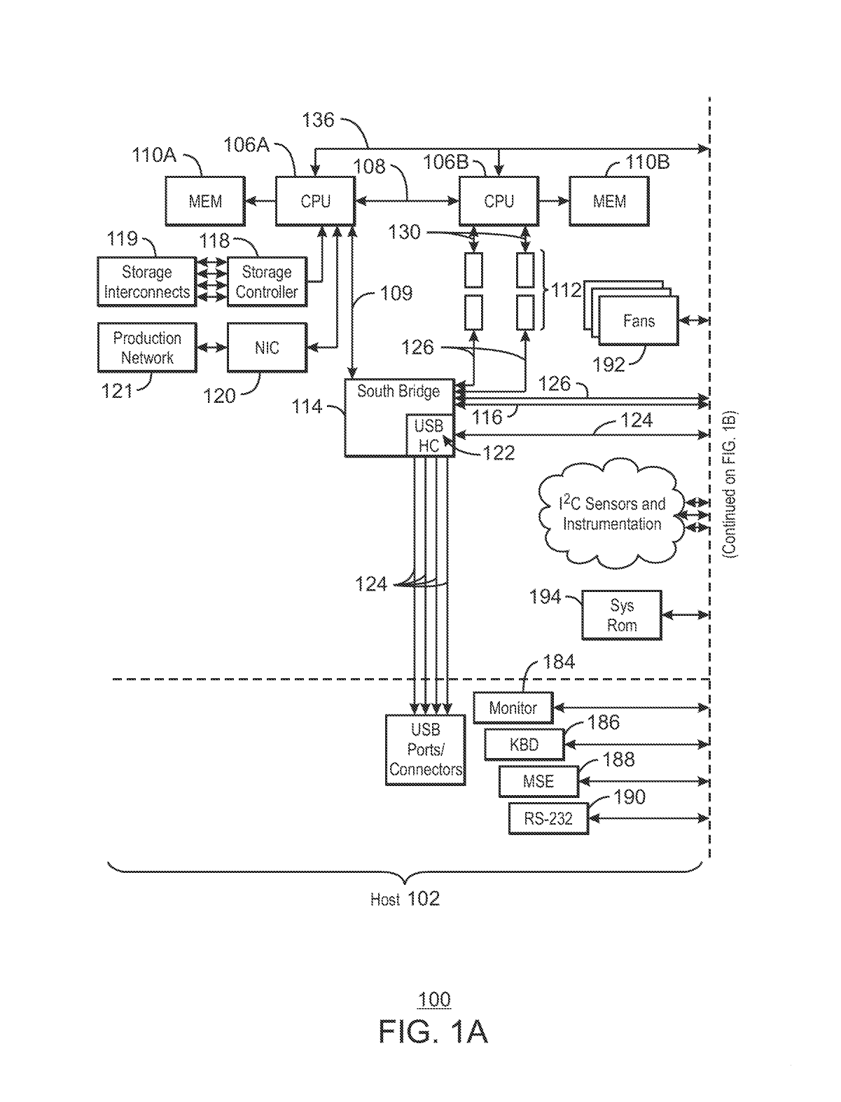

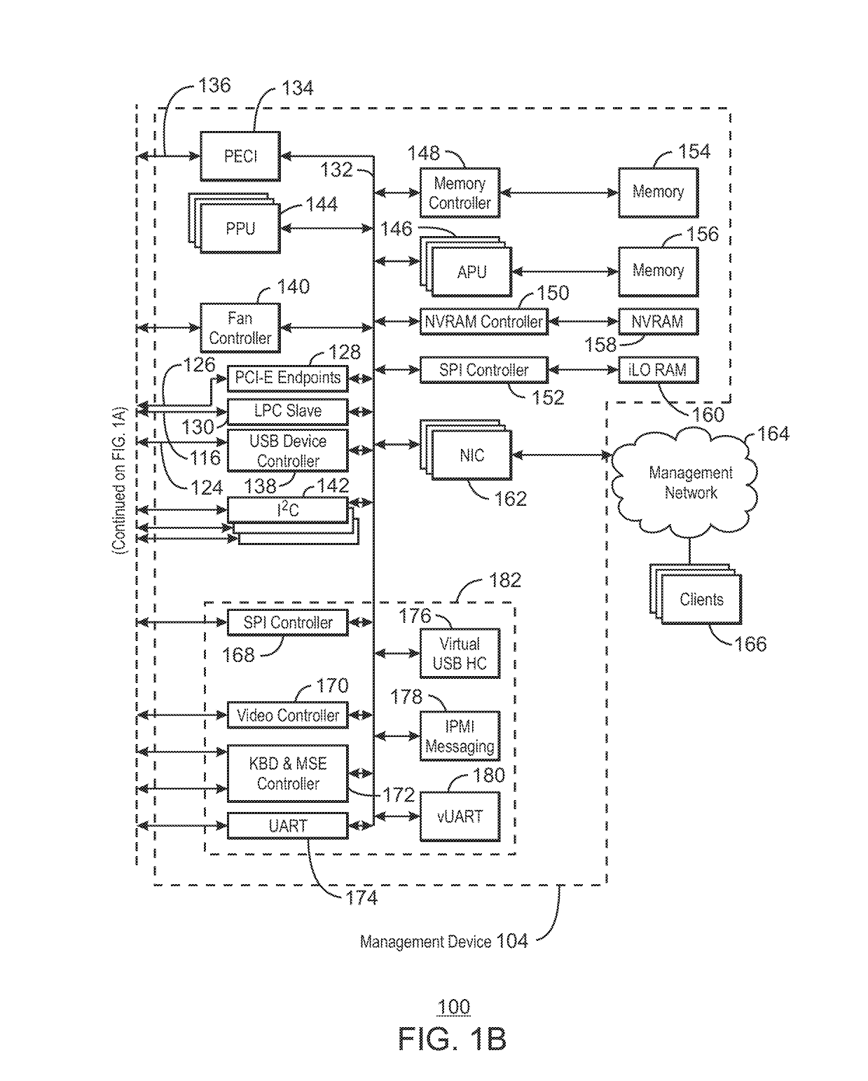

FIG. 1A is a block diagram of a managed computer system 100 according to an embodiment of the present techniques. FIG. 1B is a continuation of the block diagram of a managed computer system 100 according to an embodiment of the present techniques. The system includes a host server 102 and may be referred to as host 102. The host 102 may perform a variety of services, such as supporting e-commerce, gaming, electronic mail services, cloud computing, or data center computing services. A management device 104 may be connected to, or embedded within, host 102.

Host 102 may include one or more CPUs 106, such as CPU 106A and CPU 106B. For ease of description, only two CPUs are displayed, but any number of CPUs may be used. Additionally, the CPU 106A and CPU 106B may include one or more processing cores. The CPUs may be connected through point-to-point links, such as link 108. The link 108 may provide communication between processing cores of the CPUs 106A and 106B, allowing the resources attached to one core to be available to the other cores. The CPU 106A may have memory 110A, and the CPU 106B may have memory 110B.

The CPU 106A and 106B may offer a plurality of downstream point to point communication links used to connect additional peripherals or chipset components. The CPU 106A may be connected through a specially adapted peripheral component interconnect (PCI) Express link 109 to an input/output (I/O) controller or Southbridge 114. The Southbridge 114 may support various connections, including a low pin count (LPC) bus 116, additional PCI-E bus links, peripheral connections such as Universal Serial Bus (USB), and the like. The Southbridge 114 may also provide a number of chipset functions such as legacy interrupt control, system timers, real-time clock, legacy direct memory access (DMA) control, and system reset and power management control. The CPU 106A may be connected to storage interconnects 119 by a storage controller 118. The storage controller 118 may be an intelligent storage controller, such as a redundant array of independent disks (RAID) controller, or may be a simple command based controller such as a standard AT Attachment (ATA) or advanced host controller interface (AHCI) controller. The storage interconnects may be parallel ATA (PATA), serial ATA (SATA), small computer system interface (SCSI), serial attached SCSI (SAS) or any other interconnect capable of attaching storage devices such as hard disks or other non-volatile memory devices to storage controller 118. The CPU 106A may also be connected to a production network 121 by a network interface card (NIC) 120. Additional PCI-E links contained in both the CPU 106 and Southbridge 114 may be connected to one or more PCI-E expansion slots 112. The amount and width of these PCI-E expansion slots 112 is determined by a system designer based on the available links in CPU 106, Southbridge 114, and system requirements of host 102. One or more USB host controller instances 122 may reside in Southbridge 114 for purposes of providing one or more USB peripheral interfaces 124. These USB peripheral interfaces 124 may be used to operationally couple both internal and external USB devices to host 102. Although not shown, the Southbridge 114, the storage controller 118, PCI-E expansion slots 112, and the NIC 120 may be operationally coupled to the CPUs 106A and 106B by using the link 108 in conjunction with PCI-E bridging elements residing in CPUs 106 and Southbridge 114. Alternatively, the NIC 120 may be attached to a PCI-Express link 126 bridged by the Southbridge 114. In such an embodiment, the NIC 120 is downstream from the Southbridge 114 using a PCI-Express link 126.

The management device 104 may be used to monitor, identify, and correct any hardware issues in order to provide a stable operating environment for host 102. The management device 104 may also present supporting peripherals connected to the host 102 for purposes of completing or augmenting the functionality of the host 102. The management device 104 includes PCI-E endpoint 128 and LPC slave 130 to operationally couple the management device 104 to host 102. The LPC slave 130 couples certain devices within the management device 104 through the internal bus 132 to the host 102 through the LPC interface 116. Similarly, the PCI-E endpoint 128 couples other devices within the management device 104 through the internal bus 132 to the host 102 through the PCI-E interface 126. Bridging and firewall logic within the PCI-E endpoint 128 and the LPC slave 130 may select which internal peripherals are mapped to their respective interface and how they are presented to host 102. Additionally, coupled to internal bus 132 is a Platform Environmental Control Interface (PECI) initiator 134 which is coupled to each CPU 106A and CPU 106B through the PECI interface 136. A universal serial bus (USB) device controller 138 is also operationally coupled to internal bus 132 and provides a programmable USB device to the host 102 through USB bus 124. Additional instrumentation controllers, such as the fan controller 140 and one or more I²C controllers 142 provide environmental monitoring, thermal monitoring, and control of host 102 by management device 104. A Primary Processing Unit (PPU) 144 and one or more Autonomous Processing Units (APUs) 146 are operationally coupled to the internal bus 132 to intelligently manage and control other operationally coupled peripheral components. A memory controller 148, a NVRAM controller 150, and a SPI controller 152 operationally couple the PPUs 144, the APUs 146, and the host 102 to volatile and non-volatile memory resources. Memory controller 148 also operationally couples selected accesses from the internal bus 132 to the memory 154. An additional memory 156 may be operationally coupled to the APU 146 and may be considered a private or controlled resource of the APU 146. The NVRAM controller 150 is connected to NVRAM 158, and the SPI controller 152 is connected to the integrated lights out (iLO) ROM 160. One or more network interface controllers (NICs) 162 allow the management device 104 to communicate to a management network 164. The management network 164 may connect the management device 104 to other clients 166.

A SPI controller 168, video controller 170, keyboard and mouse controller 172, universal asynchronous receiver/transmitter (UART) 174, virtual USB Host Controller 176, Intelligent Platform Management Interface (IPMI) Messaging controller 178, and virtual UART 180 form a block of legacy I/O devices 182. The video controller 170 may connect to a monitor 184 of the host 102. The keyboard and mouse controller may connect to a keyboard 186 and a mouse 188. Additionally, the UART 174 may connect to an RS-232 standard device 190, such as a terminal. As displayed, these devices may be operationally coupled physical devices, but may also be virtualized devices. Virtualized devices are devices that involve an emulated component such as a virtual UART, or virtual USB devices. The emulated component may be performed by the PPU 144 or the APU 146. If the emulated component is provided by the PPU 144 it may appear as a non-functional device should the PPU 144 enter a degraded state.

The PECI initiator 134 is located within the management device 104, and is a hardware implemented thermal control solution. A PPU 144 will use the PECI initiator 134 to obtain temperature and operating status from the CPUs 106A and 106B. From the temperature and operating status, the PPU 144 may control fan speed by adjusting fan speed settings located in a fan controller 140. The fan controller 140 may include logic that will spin all fans 192 up to full speed as a failsafe mechanism to protect host 102 in the absence of control updates from the PPU 144. Various system events can cause the PPU 144 to fail to send updates to the fan controller 140. These events include interruptions or merely a degraded mode of operation for the PPU 144. When the PPU 144 fails to send updates, a brute force response action, such as turning the fans 192 on full speed, may be the only course of action.

The APU 146 may be configured to perform low level functions, such as monitoring the operating temperature, fans 192, and system voltages, as well as performing power management and hardware diagnostics. Low level functions may be described as those functions performed by the PPU 144 that are used to provide a stable operating environment for the host 102. Typically these low level functions may not be interrupted without a negative effect on the host 102. The host 102 may be dependent on the PPU 144 for various functions. For example, a system ROM 194 of host 102 may be a managed peripheral for the host 102, meaning that host 102 depends on the PPU 144 to manage the system ROM 194.

In the event that the PPU 144 is unavailable, unresponsive, or in a degraded state during operation, the host 102 and other services expecting the PPU 144 to respond may experience hangs or the like. The software running on the PPU 144 is much more complex and operates on a much larger set of devices when compared to an APU 146. The PPU 144 runs many tasks in a complex multi-tasking OS. Due to the increased complexity of the PPU 144, it is much more susceptible to software problems. An APU 146 is typically given a much smaller list of tasks and would have a much simpler codebase. As a result, it is less probable that complex software interactions with the APU 146 would lead to software failures. The APU 146 is also much less likely to require a firmware upgrade, since the APU's 146 smaller scope lends itself to more complete testing.

For example, if the PPU 144 is unavailable, the virtualized devices that involve an emulated component may be unavailable. This includes devices such as a virtual UART 180 or virtual USB host controller 176. The emulated component may be performed by the PPU 144 or the APU 146 as discussed above. In a similar vein, the only means to monitor and adjust the temperatures of CPU 106A and CPU 106B when PPU 132 is unavailable would be through the hardware implemented fan controller 140 logic that will spin all fans 192 up to full speed as a failsafe mechanism in the absence of control updates from the PPU 144. However, when the PPU 144 has an unexpected failure, the APU 146 may be used to automatically bridge functionality from the PPU 144. In embodiments, when the PPU 144 is unavailable, the APU 146 may automatically perform various low level functions to prevent a system crash. For ease of description, only one APU is displayed, however there may be any number of APUs within the management device 104.

In additional to automatically taking over in the event that the PPU 144 is unavailable, as in the case of a reboot of the PPU 144, the PPU 144 may off load certain functions to an APU 146 before a scheduled PPU 144 outage. In other words, when the PPU 144 is scheduled to be unavailable, as in the case of a re-boot, the APU 146 may be assigned to take over those low level functions performed by the PPU 144. For example, the PPU 144 may be scheduled for a planned firmware upgrade. In this scenario, the APU 146 may automatically provide a backup to the functionality of the PPU 144, albeit at a reduced processing level.

In embodiments, the APU 146 may run alongside the PPU 144 with the APU 146 continuously performing low level functions, regardless of the state of the PPU 144. Additionally, in embodiments, various functions may be offloaded from the PPU 144 to the APU 146 when PPU processing is limited or unavailable. The APU 146 may also provide the same functionality of the PPU 144 at a courser, or degraded, level in order to ensure continued operation the management device 104. Thus, the APU 146 may be configured to provide a reduced functionality relative to the primary processing unit. The APU 146 may also be configured to detect an outage or failure of the PPU 144.

In embodiments, the APU 146 may be designated particular functions and “lock down” those functions from being performed by any other APU or the PPU 144. By locking down specific functions, a hardware firewall can prevent errant bus transactions from interfering with the environment of the APU 146. Further, in embodiments, the PPU 144 may initialize each APU 146.

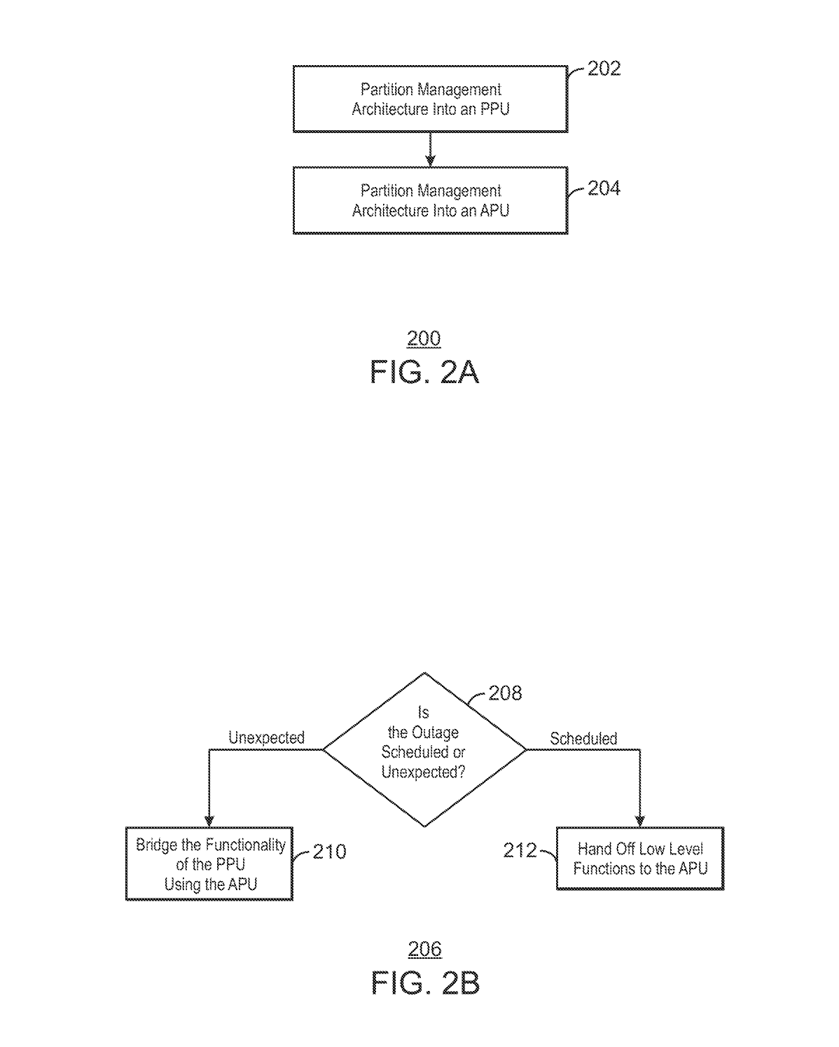

FIG. 2A is a process flow diagram showing a method 200 of providing a managed computer system according to an embodiment of the present techniques. At block 202, a management architecture may be partitioned into a primary processing unit that performs general system management operations of the computer. System management operations include, but are not limited to, temperature control, availability monitoring, and hardware control. At block 204 the management architecture may be partitioned into an autonomous processing unit that performs low level functions during a time interval when the primary processing unit is unavailable. The primary processing unit, such as a PPU, may be unavailable for management operations upon encountering a variety of operating scenarios. These scenarios include, but are not limited to, a PPU reboot, a PPU hardware failure, a PPU watchdog reset, a PPU software update, or a PPU software failure. The techniques are not limited to a single autonomous processing unit, such as an APU, as multiple APUs may be implemented within a managed computer system. The low level functions performed by the APU may be described as functions performed by the PPU that are used to provide a stable operating environment for a host processor. In embodiments, the APU may perform low level functions/tasks while the PPU is in operation, as described above.

FIG. 2B is a process flow diagram showing a method 206 of performing low level functions according to an embodiment of the present techniques. The method 206 may be implemented when running low level functions according to block 204 (FIG. 2A) in the event of an outage or failure by the PPU. At block 208, it is determined if the outage is scheduled or unexpected. If the outage is unexpected, process flow continues to block 210. If the outage is scheduled, process flow continues to block 212.

The outage of the PPU may be detected in many ways. For example, a hardware monitor can be attached to PPU that watches for bus cycles indicative of a PPU failure, such as with a PPU OS panic or a reboot. The monitor could watch for a fetch of the PPU exception handler or a lack of any bus activity at all over a pre-determined amount of time, indicating the PPU has halted. Alternatively, a watchdog timer can be used to detect loss or degradation of PPU functionality. In this approach, a process running on the PPU resets a count-down watchdog timer at predetermined time intervals. If this timer ever counts down to 0, an interrupt is invoked on the APU. This instructs the APU that the PPU has lost ability to timely process tasks.

The outage of a PPU can also be detected by a device latency monitor. Using a device latency monitor, devices being emulated or otherwise backed by PPU firmware can be instrumented to signal an interrupt whenever an unacceptable device latency is encountered. For example, if the PPU is performing virtual UART functions but has not responded to incoming characters in a predetermined time period, the APU may be signaled to intervene, taking over the low level device functions to prevent system hangs. In this example, the system may hang waiting for the characters to be removed from the UART FIFO. The system designer may choose for the APU to simply dispose of the characters to prevent an OS hang, or the system designed can instrument the APU to completely take over the UART virtualization function in order to preserve complete original functionality of the management subsystem.

An APU device poll may also be used to detect a PPU outage. In an APU device poll, the APU may detect a PPU failure by polling devices to insure the PPU is performing tasks in a timely manner. The APU intervenes if it detects a condition that would indicate a failed PPU through its polling. The APU may also engage in active measurement of the PPU to detect a PPU outage. The APU may periodically signal the PPU while expecting a predetermined response from the PPU. In the event the PPU incorrectly responds to the request or is unable to respond to the request, the APU will take over the tasks of the PPU.

At block 210, the functionality of the PPU is bridged using the APU until the PPU is functional. In other words, the APU is assigned functions from the PPU when the PPU is unexpectedly unavailable. In this scenario, there has been an immediate and unexpected failure of the PPU. At this point, the APU bridges functionality of the low level functions to provide a stable environment for the host system. Once again, the functionality provided to the host system by the APU may be degraded from the capabilities of the PPU.

At block 212, low level functions may be “handed-off” to the APU in the case of a scheduled outage. The low level functions may be handed off to the APU until the PPU is fully functional. In this scenario, the APU becomes responsible for running various low level functions in order to maintain a stable environment for the host system. While the APU may not have the same processing power of the PPU, the APU can maintain a stable environment for the host system at a degraded functionality.

When the APU takes over, it may take over the task, completely preserving the entire intended process function. This may leave the device in a degraded state from a performance standpoint. However, all functionality is preserved. The APU may also take over the task, but in a degraded operating state. For example, the APU may only want to prevent host lockups but not necessarily preserve the entire function. In the case of emulating a USB device, the APU may only perform those functions that would prevent the OS from detecting a bad device. However, it may choose to only perform a limited function. The APU may wish to signal a “device unplugged” event to the OS to prevent further mass storage reads/writes that it is not capable of servicing. To the OS, it appears as though a USB device may be unplugged instead of the device being plugged in and malfunctioning. Finally, the APU may also take over the task, but hold it in a device acceptable “wait” condition. This would defer device servicing until the PPU can be restored.

The functions being run by the APU may also be locked down. When the APU is locked down, the PPU may perform functions of the APU on a request or grant basis. For example, functions related to timing or security may be assigned to the APUs for execution. When the APUs are locked, the particular functions assigned to particular APUs may be prevented from running on the PPU or other APUs and from adversely affecting a particular APU's function. Additionally, locking the APUs may restrict the PPU to performing functions previously granted to it. This may include locking out other PPU or APUs from using a particular set or subset of peripherals, memory, or communication links. In this manner, the APUs may be immune or highly tolerant of PPU reset or management reset events. This may allow the APUs to maintain various features or functional capabilities while the PPU is being reset.

The PPU may perform other functions not designated to it or other APUs on a request or grant basis. For example, if the PPU wishes to reset a particular APU but does not have that privilege, it may request the reset and the APU may grant permission to the PPU to perform the reset. This request/grant mechanism may harden the APU from PPU faults or other events that might interfere with the function of the APUs.

Interface software running on the host computer may be connected to firmware running on the APU, thereby making it immune to PPU reset or fault events. The firmware running on the APU may be limited in scope, size, and complexity, so that the function of the APU can be thoroughly tested and audited. More than one function may be assigned to an APU and it may or may not run the same embedded OS or firmware as the PPU. Additionally, the APU can be assigned lower level, critical functions regardless of the status of the PPU. Assigning lower level, critical functions to the APU, regardless of the status of the PPU, frees the PPU from dealing with those functions and PPU failures do not need to be detected. In such a scenario, the PPU always works on “higher brain tasks.” The APUs can be relied on to handle the lower level, critical functions without crashing because these types of functions are less susceptible to crashes when compared to the higher level brain functions performed by the PPU.

In a scenario where the PPU is re-booted, functions may migrate from the PPU to the APU or from the APU to the PPU. For example, the PPU can boot an embedded OS to establish operational functions, and then delegate functions to the APUs once the functions have been tested and verified as operational. The architecture may include features to assign peripherals, memory, interrupts, timers, registers or the like to either the PPU or the APU(s). This may allow certain hardware peripherals to be exclusively assigned to a particular APU and prevent interference by other APUs or the PPU.

Using an analogy to physiological functions, a person may be unconscious with the heart and lungs remaining fully functional. Likewise, the PPU may serve as the brain and be responsible for higher brain functions, including, but not limited to, networking, web server, and secure sockets layer (SSL). The APUs may be designed for those functions such as the heart and lungs, which may ensure a functioning host server. Thus, the APU may be configured to provide a reduced functionality relative to the PPU, ensuring a stable operating environment for the host processor. While the host processor system may lose the functionality of the PPU, the APU may ensure continuous operation of the system by providing any low level function. Additionally, in embodiments, firmware of the APU may be easier to audit due to smaller codebases for the firmware processes. Moreover, delicate portions of firmware may be protected from future architectural changes. The PPU may change from generation to generation, but the APU may be fixed. The present techniques may also allow for a cost reduction, as it may no longer be obligatory to add external microcontrollers or external logic to back up a function relegated to the management processor.

In embodiments, functions such as network communication, web serving, and large customer facing features, may be implemented on a PPU, which may have more processing power when compared to the APU. The PPU may still run a complex real-time operating system (RTOS) or an embedded OS, and may employ thread safe protections and function (task) scheduling.

Host server operations that receive assistance from the management platform typically use a hardware backup in case the hardware management subsystem has failed or is otherwise unavailable. This hardware backup may result in extra hardware, failsafe timers, complicated software, or complicated firmware. The present techniques may reduce the dedicated hardware backup plans for every management assisted hardware feature. The present techniques may also allow the management platform to implement latency sensitive features, and the techniques may improve latency and the amount of CPU resources available to address timing features that may lead to host computer issues or crashes.

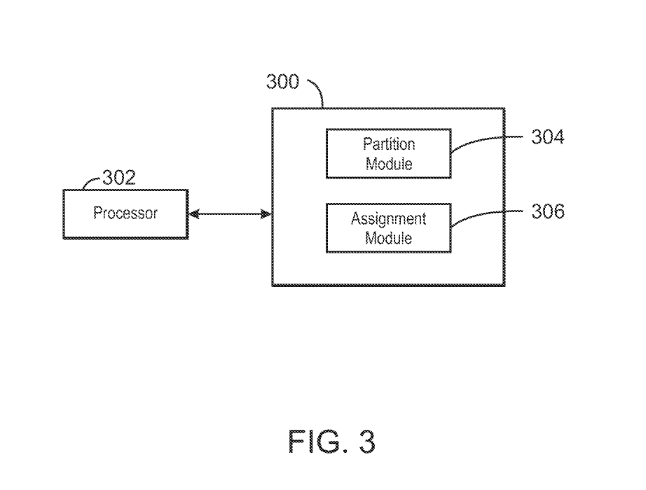

FIG. 3 is a block diagram showing a non-transitory, computer-readable medium that stores code for managing a computer according to an embodiment of the present techniques. The non-transitory, computer-readable medium is generally referred to by the reference number 300.

The non-transitory, computer-readable medium 300 may correspond to any typical storage device that stores computer-implemented instructions, such as programming code or the like. For example, the non-transitory, computer-readable medium 300 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 302 generally retrieves and executes the computer-implemented instructions stored in the non-transitory, computer-readable medium 300 for providing a robust system management processor architecture. At block 304, a partition module provides code for partitioning functions to a primary processing unit and an APU. At block 306, an assignment module provides code for performing low level functions using the APU.

What is claimed is:

1. A managed computer system, comprising:
a host processor;
a management subsystem that includes a primary processor, the primary processor performing system management operations of the computer; and
an autonomous management processor that is assigned to perform low level functions during a time interval when the primary processor is unavailable.

2. The managed computer system recited in claim 1, wherein the low level functions comprise functions that are used to provide a continuous operating environment for the host processor.

3. The managed computer system recited in claim 1, wherein the autonomous management processor is assigned functions from the primary processor before the primary processor is scheduled to be unavailable.

4. The managed computer system recited in claim 1, wherein the autonomous management processor detects a failure or outage of the primary processor.

5. The managed computer system recited in claim 1, wherein the autonomous management processor provides a reduced functionality relative to the primary processor.

6. The managed computer system recited in claim 1, wherein a failure of the primary processor is detected by:
a hardware monitor attached to the primary processor that watches for bus cycles indicative of the failure of the primary processor;
a watchdog timer that detects loss or degradation of the primary processor's functionality;
a device latency monitor that signals an interrupt whenever an unacceptable device latency is encountered in a device emulated or backed by the primary processor; or
an autonomous management processor device poll that polls devices to insure the primary processor performs tasks in a timely manner.

7. The managed computer system recited in claim 1, wherein the autonomous management processor continuously performs low level functions.

8. A method of providing a managed computer system, comprising:
partitioning a management architecture into a primary processing unit that performs general system management operations of the computer; and
partitioning the management architecture into an autonomous processing unit that performs low level functions during a time interval when the primary processing unit is unavailable.

9. The method of providing a managed computer system recited in claim 8, wherein the low level functions comprise functions that are used to provide a stable operating environment for a host processor.

10. The method of providing a managed computer system recited in claim 8, wherein the autonomous processing unit is assigned functions from the primary processing unit before the primary processor processing unit is scheduled to be unavailable.

11. The method of providing a managed computer system recited in claim 8, comprising:
assigning functions to the autonomous processing unit;
locking the functions assigned to the autonomous processing unit; and
allowing the primary processing unit to perform the assigned functions on a request or grant basis.

12. The method of providing a managed computer system recited in claim 8, comprising:
detecting a failure or outage of the primary processing unit; and
performing functions of the primary processing unit by the autonomous processing unit during the failure or outage.

13. The method of providing a managed computer system recited in claim 8, comprising monitoring the functions performed by the primary processing unit.

14. The method of providing a managed computer system recited in claim 8, wherein the autonomous processing unit performs low level functions while the primary processing unit is available.

15. A non-transitory, computer-readable medium, comprising code configured to direct a processor to:
partition the management architecture into a primary processing unit that performs general system management operations of the computer; and
partition the management architecture into an autonomous processing unit that performs low level functions during a time interval when the primary processing unit is unavailable.
